(19) United States
(12) Patent Application Publication
(10) Pub. No.: US 2005/0180134 A1
(43) Pub. Date: Aug. 18, 2005

(54) Means of Achieving a Lambertian Distribution Light Source via a Light Emitting Diode Array

(76) Inventors: Robert Dal Sasso, Blackburn (AU); David B. Logan, Blackburn (AU); William B. Phelan, Blackburn (AU)

Correspondence Address: Ecotech, 49 Barnsdale Rd, East Providence, RI, 02914, US

(21) Appl. No.: 10/906,160

(22) Filed: Feb. 4, 2005

Related U.S. Application Data
(60) Provisional application No. 60/521,079, filed on Feb. 18, 2004.

(51) Int. Cl. F21V 9/00

(52) U.S. Cl. 362/230

(57) ABSTRACT

A semi-circular LED array that is comprised of independent high intensity LED components and which in combination, will emit a focused single wavelength of highly accurate and precise frequency, in accordance with the Lambertian principle. The resultant combined light source can then be used in combination with an integrating nephelometer, for purposes of precise ambient air quality monitoring. The entire LED array and housing chamber can be easily interchanged to facilitate separate and different wavelength light sources, as required. The user can, when desired, easily remove the entire LED array, and replace with another LED array of different total wavelength capability. Thus a considerably more versatile and accurate light source is provided for use in nephelometry, that can be automatically adjusted via discrete circuitry to provide a precise and accurate specific wavelength light source, which removes any requirement for external light filters, and which provides significantly increased long life and significantly reduced maintenance requirements. The overall effect is a very stable Light Source which produces a fixed wavelength of light with a distribution that is Lambertian.

### CROSS REFERENCE TO RELATED APPLICATIONS

This application claims the benefit of PPA Application No. 60/521,079 filed on Feb. 18, 2004 by the present inventors.

### BACKGROUND OF THE INVENTION

This invention relates to the means of using of high intensity light emitting diodes (hereafter referred to as LEDs) mounted in a specific array such that a lambertian concentrated light source is obtained. We wish to patent the means by which we are achieving a lambertian light source distribution, specifically the means of achieving light intensity via a specially designed LED array, and our resultant ability to be able to continuously adjust the shape of the light distribution by varying the currents to each LED in said array. We developed a lambertian light source that is close to ideal, for a specific use (in an integrating nephelometer). Our light source could also be used in other future applications.

For our own specific nephelometer application, we needed to achieve an ideal lambertian light source that would consist of a point source of light providing a cosine distribution as a function of angle. We also required the light source to produce no radiated heat, as well as requiring minimal power consumption. The wavelength of the ideal light source needed be of a very narrow band width. The light output intensity of the light source should ideally be very stable and not vary with temperature changes. To our best knowledge there has never been an ideal light source developed that could meet these needs, and we have created a lambertian light source that is as close to ideal as possible.

The resulting light source can be used for various purposes, one example is as a suitable light source for an integrating nephelometer, which requires a high intensity light source within a photomultiplier tube, subject to specific ideal light source requirements. Namely that the light source must provide a cosine distribution wavelength as a function of angle, must produce no radiated heat, must require minimal power consumption, must emit wavelength of a very narrow band width, and with a light output intensity that is very stable and does not vary with temperature changes. All of this must be achieved at low cost and with minimal maintenance requirements. Our invention has just recently been used successfully within an integrating nephelometer to enable a more highly accurate continuous measurement of the light scattering coefficient of fine particulates in an air sample, hence providing a useful measure of ambient air quality. In the past, integrating nephelometers have utilized high intensity incandescent flash lamps in combination with various colored filters in order to create a specific wavelength light source. However, these type of lamps are prone to regular maintenance requirements, are expensive to replace, and are far less accurate because the length of light source flash time is relatively small, which means that a reading of visibility must be taken quickly. Our invention incorporates intelligent use of LED's. In fact it is only very recently that LEDs have been manufactured that can emit a high enough intensity in order to operate effectively as a component of our invention. Light emitting diodes (LEDs) are available in red, green, and blue, and have turn-on times well below 1 microsecond. Until recently, luminance and light output of LEDs were not sufficient to obtain strong performances as an intense light source. However, with the recent introduction of LED technological advances, it has now been possible for us to develop our invention which includes a special controllable array of multiple high intensity LED's and controllable currents to each LED, resulting in a controllable and very close to ideal lambertian light source.

The new type of high intensity LEDs we are utilizing in our invention are now available in powerful wattages, with a very high efficiency. High intensity LED's are already being used in various applications that require strong visibility, such as traffic lights and rear brake lights on buses and large trucks. However there are no arrays of LEDs where each separate LED in the array has a discrete and controlled electronic current via an employed circuit which individually controls the current through each LED, in order to obtain a resulting total stable combined light intensity with a lambertian distribution at a specific constant and continuous narrow wavelength output. The light source circuitry also employs a temperature compensation circuit so that the output intensity of the light source does not vary with changes in ambient temperature. Because LEDs are very efficient, there is minimal heating of the light source from the LEDs. This means that no additional cooling or heat dissipation is required.

Recently we began to utilizing this invention for the purpose of acting as a reliable low maintenance long life lambertian light source for an integrating nephelometer, which has provided significant benefits including longer flash time and greater accuracy at less overall cost, and with significantly less maintenance requirements. Further, other optical systems require constant maintenance to clean the lenses and filters through which the optics are directed. Our invention requires minimal maintenance, since our components are long lasting and have minimal maintenance requirements. Whilst we are currently beginning to use our invention as an advanced and significantly improved light source for a new integrating nephelometer, there are also various other multiple potential uses for the invention. As such, this invention is not solely limited to a light source for an integrating nephelometer. Similarly the said light source LED array is not limited to its current form that is in a semi-circular arrangement, but may be in the form of other physical arrangements of LED's. Similarly the said array of LED's is not limited to the current circuit controlled means used, but may involved other circuitry or microprocesser algorithms to achieve the same resuls. Similarly our invention may be used in future to control and maintain more than one specific alternative user selectable wavelength within the same configuration. In other words the user may be able to select a wavelength of say 525 nm for one application, then switch to an alternative wavelength of 450 nm for a second application either via the same LED array system light source, or via a concurrent LED array system light source.

There are many examples of alternative light sources historically used within nephelometers and other visibility sensors to achieve a necessary fixed wavelength intensity. U.S. Pat. No. 6,330,519 to Sawatari (2001) shows a visibility sensor system which includes a housing having a sensor head opening with an electronics module coupled to the sensor head through the connector, with a light source being configured to emit a light beam through apertures to illuminate a sample volume located outside of the apparatus. However Sawatari's light source does not utilize individually controllable high intensity LED's, nor does it utilize an array of said LED's, combined and controlled in such a manner as to create a continuous and highly accurate specific wavelength. A microprocessor signal is utilized in Sawatari's invention, however this is for the purpose of sensing and changing the invention's signal and to then trigger external operations as a result of external factors such as precipitation. Eg Sawatari's said microcontroller is configured to generate an external precipitation signal in accordance with a variation parameter associated with an output signal. Sawatari's invention provides no means to maintain continuous control of the light source wavelength.

There are many examples of optical analyzers that measures light directed from a sample to the detector. U.S. Pat. No. 6,084,680 to Tuunanen, et al. (2000) includes an optics module which has a detector and optics for directing light emitted by the sample to the detector. However it uses various filters to achieve the necessary wavelength requirements for measuring optical properties of a sample, and the source of light used is an incandescent bulb which has inherent limitations, and its resulting wavelength of light emitted cannot be controlled without using external filters through which light passes to generate required wavelengths. Similarly U.S. Pat. No. 6,020,961 to Moore (2000) also refers to the use of a light source for the purpose of nephelometery, but in this case refers to an illumination device in the form of a laser, which concerns entirely separate properties. Moore's invention concerns itself with the nature of the light source being either of a halogen lamp or of a laser type source. As mentioned above, use of halogen lamp has significant inherent limitations. Use of a laser does certainly have the potential to provide a very narrow frequency bandwidth as a light source, but it is a distinctly different type of light source with different means of operation in comparison to our specific use of an LED array lambertian light source. In a similar manner, U.S. Pat. No. 5,751,423 to Traina, et al. (1998) utilizes an optical assembly containing a solid state light source listed as “preferably a solid-state laser”, but this invention makes minimal reference to the specific nature of the light source, which by definition as a laser, would greatly differ to our invention. Claims as to whether the use of a laser as a light source versus use of a controlled array of high intensity LED's are subject to debate and we can provide arguments that use of our specially configured LED array is actually superior to use of a laser. However, the fact that each light source is significantly different is of utmost import, and each has its own advantages and disadvantages. In summary, none of the above mentioned invented light sources for use in nephelometers is similar in design or operation to our invention.

U.S. Pat. No. 6,055,052 to Lilienfeld (2000), utilizes two seperate optical sensors to measure light scattering. Lilienfeld's invention makes reference to use of two independent LED's to achieve 2 concurrent multiple wavelengths with the first LED light source operating at a wavelength chosen from the range of approximately 550 nm to approximately 600 nm and the second LED light source operating at a wavelength chosen from the range of approximately 880 nm to about 950 nm, wherein the system comprises control logic that activates the first and second light sources in an alternating manner for predefined activation pulse durations. However, this invention is focused on converting humidity levels in air to appropriate measurement levels, in combination with the two separate light source wavelengths. Conversely, our invention utilizes LED's in a specific semi-circular array to focus multiple LED's upon one small point, with the multiple LED's acting in combination but separately to ensure a very high intensity light source which also closely approximates an ideal lambertian source, providing a cosine distribution as a function of angle, resulting in a very high intensity light source with a very precise wavelength. Our invention can be used to accurately provide separate light source wavelengths but in a very different and improved manner to the Lilianfeld invention, by providing two separate full arrays in concert, with each individual LED in each array being actively controlled via the LED array circuitry, with a resulting distinct total wavelength light frequency that is significantly more reliable than the use of just one LED per wavelength as proposed in the Lilianfeld invention. Also our invention is not specifically concerned with a two wavelength operation, though it can be used in that format. Through the use of either multiple unique and separate LED arrays we can precisely and accurately approximate single wavelength, dual wavelength, or even triple wavelength light sources.

U.S. Pat. No. 5,461,476 to Fournier (1995) utilizes a plurality of light detectors, wherein each light detector is positioned to receive light from a single source. This differs significantly from the Ecotech invention, which instead utilizes a plurality of independently controlled light sources in the form of a semi-circular array of high intensity LED's to obtain a combined very high intensity accurate wavelength frequency for use in nephelometry applications.

In addition to the above patent references, a detailed public internet search conducted by us revealed another example of specific combined use of LED's, at http://64.233.161.104/search?q=cache:k35G7CQwx00J:www.lumileds.com/solutions/LCD/03IDWHarbers.pdf+Performance%2Bof%2BHighPower%2BLED%2Billuminators%2Bin%2BProjection%2BDisplays&hl=en

This design incorporates use of high intensity LEDs as a lambertian light source in a projector. However, it differs significantly from our invention because via the LED array circuitry we can adjust the shape of the resultant light distribution by varying the currents to each LED. You cannot do this with the Lexeon LEDs that are discussed in the cited internet web reference.

In conclusion, insofar as we are aware, there is has never been formerly developed a lambertian LED light source array incorporating circuitry control of individual LED's to achieve an accurate and continuously adjustable fixed wavelength frequency light source, that is suitable for use in nephelometry, or other related applications.

### SUMMARY OF THE INVENTION

The invention is a lambertian LED light source array comprising circuitry control of individual LED's to achieve an accurate and continuous fixed wavelength frequency light source, that closely approximates a lambertian distribution and that is highly suited for use in nephelometry, or other related applications. As a light source for use in nephelometry, this invention facilitates accurate measurement of the light scattering of particulate matter in order to provide a continuous measurement of air quality, and also provides for low maintenance, precise, long life operation. It also enables the user to quickly change the light source by switching in and out different arrays of LED's, with the same microprocessor being able to adjust accordingly for each different array. The said invention can then be incorporated into an integrating nephelometer providing for more accurate measurement, significantly less maintenance requirements, and quicker response times, and at a significantly lower cost than achieved by alternative light sources. The other unique feature of the light source circuitry is that it also employs a temperature compensation circuit so that the output intensity of the light source does not vary with changes in ambient temperature. Because LEDs are very efficient, there is minimal heating of the light source from the LEDs. This means that no additional cooling or heat dissipation is required.

Accordingly several objects and advantages of the invention are:

To provide improved benefits of accurate measurement of the light scattering of particulate matter in order to provide a continuous measurement of air quality, namely more precise results due to increased flash length capabilities and more precise wavelength frequency capability.

To provide a very stable light source which produces a fixed wavelength of light with a distribution that is Lambertian.

To provide for low maintenance since the light source is more easily cleaned than other alternative light sources, and has a very long life time in comparison to other light sources which require more regular cleaning and replacement.

To enable users to quickly change the light source light frequency by switching in and out different self contained arrays of LED's, with the same microprocessor being able to be reused and adjust automatically for each different array.

To provide a suitable Lambertian light source with a significantly lower cost than achieved by alternative light sources.

To avoid the need for additional cooling or heat dissipation.

### DRAWINGS

FIG. 1 shows a side by side exploded front view, sectioned view, and assembled view of the LED array inside the housing.

FIG. 2 is a technical top view illustrating the nature of the LED array circuitry that is used to control each independent LED within the array.

FIG. 3 is right three quarter view of the light housing and diffuser for the LED array constructed in accordance with the invention.

FIG. 4 is graph indicating how the invention during testing approximates an ideal lambertian light source by providing a cosine distribution output as a function of angle.

FIG. 5A is a modular view of a newly available commercial nephelometer incorporating our LED array light source invention 50. FIG. 5B show the actual commercial nephelometer incorporating LED array light source invention 50.

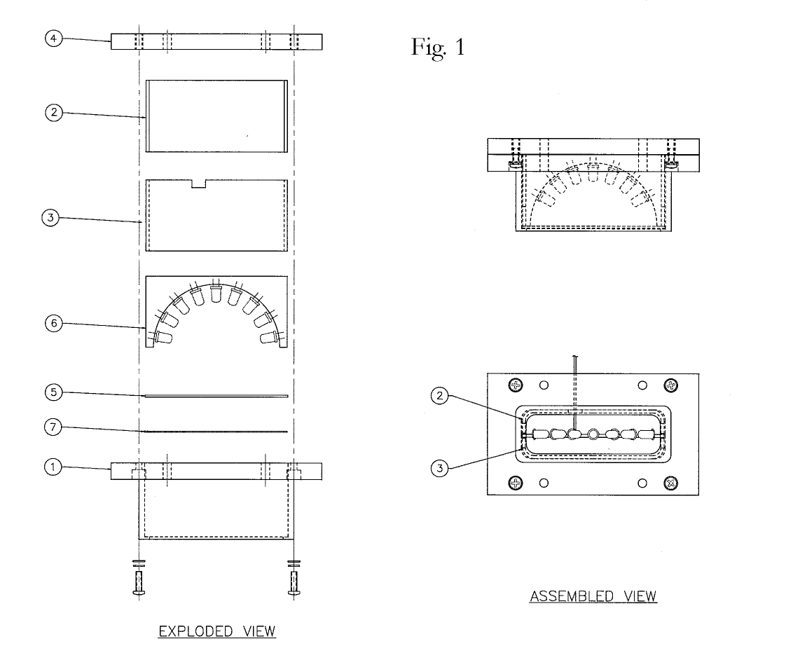

### DETAILED DESCRIPTION—FIG. 1 TO 5

FIG. 1 shows a side by side exploded front view, assembled view, and sectioned view of the LED array inside the housing. The LEDs are arrayed in a semi-circular arrangement on an LED Array Printed Circuit Assembly (PCA) 06. The PCA is mounted inside the Light source Housing 01, comprised of a PCA Mounting Bracket Top 02, PCA Mounting Bracket Bottom 03, and Housing Top Plate 04. A Light Source Diffuser 05 and Diffuser Sealant 07, are also incorporated.

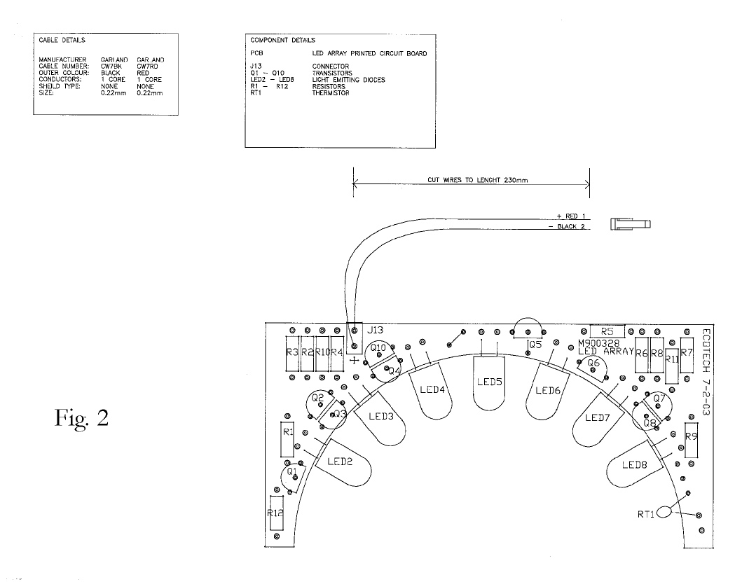

FIG. 2 is a technical top view illustrating the LED array printed circuitry assembly, that is used to control each independent LED within the array. The Light source consists of seven Light Emitting Diodes (LED) of a very high output intensity (often called super bright LEDs). These LEDs are chosen for not only their very bright output, but also their wavelength (or colour). The wavelength output (typically 525 nm) is very stable and should not vary by more than 30 nm. Other wavelengths can be achieved by using different wavelength LEDs (700 nm for Red, 450 nm for Blue). The light intensity of each LED is kept very stable. The light output intensity of each LED is directly proportional to the amount of current flowing through the LED, hence current also has to be stable. The LEDs have a narrow beam width angle of 15 degrees, so that most of the light energy can be focused in one spot. If the light output intensity of each LED was the same, then the combined output distribution of the light source would not be lambertian. That is why we have employed circuitry which individually controls the current through each LED. Each LED is given a discrete driving current (depending on the angular location of the LED) so that the combined effect of all the LEDs is a lambertian distribution. The overall Intensity of the Light Source assembly can be varied by increasing the drive voltage to Light Source. Hence the subsequent current through each LED also will vary accordingly, however the variation in each LED current will be in proportional so as to maintain a lambertian light distribution. The other unique feature of the light source circuitry is that it also employs a temperature compensation circuit so that the output intensity of the light source does not vary with changes in ambient temperature. Because LEDs are very efficient, there is minimal heating of the light source from the LEDs. This means that no additional cooling or heat dissipation is required.

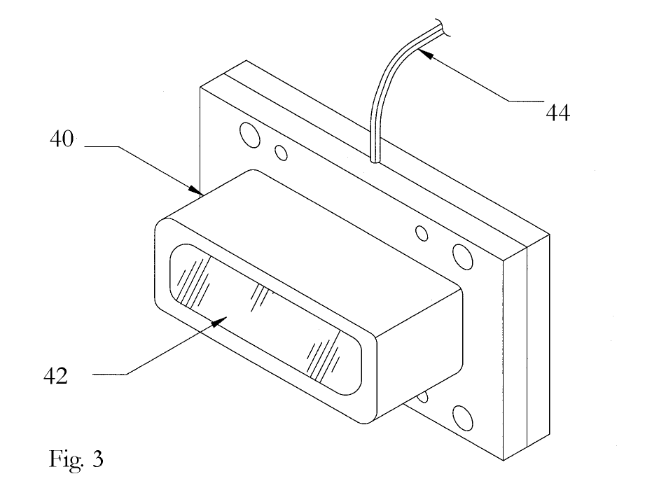

FIG. 3 is right three quarter view of the light source housing and diffuser for the LED array constructed in accordance with the invention. The LEDs are arrayed in a semi-circular arrangement inside the housing 40, and adjusted so that each LED is focused on the same spot. Hence this produces a very high concentration of light in the one position. At the point where these LEDs are focused, there is a glass diffuser window 42. The diffuser performs two functions: It evenly distributes the incident light 170 degrees from the diffuser, and it pneumatically seals the electronic components from the ambient air. The Light source housing provides the means by which the LED Array Printed Circuit Assembly and the Diffuser can be mounted and sealed. The housing contains mounting brackets inside to keep the circuit board stable and minimize any heating effects on the ambient air. The housing is made of aluminium and is black anodised as well as having a coating of matt black paint in certain locations to reduce light reflections. A cable 44 is for power and signal communication purposes.

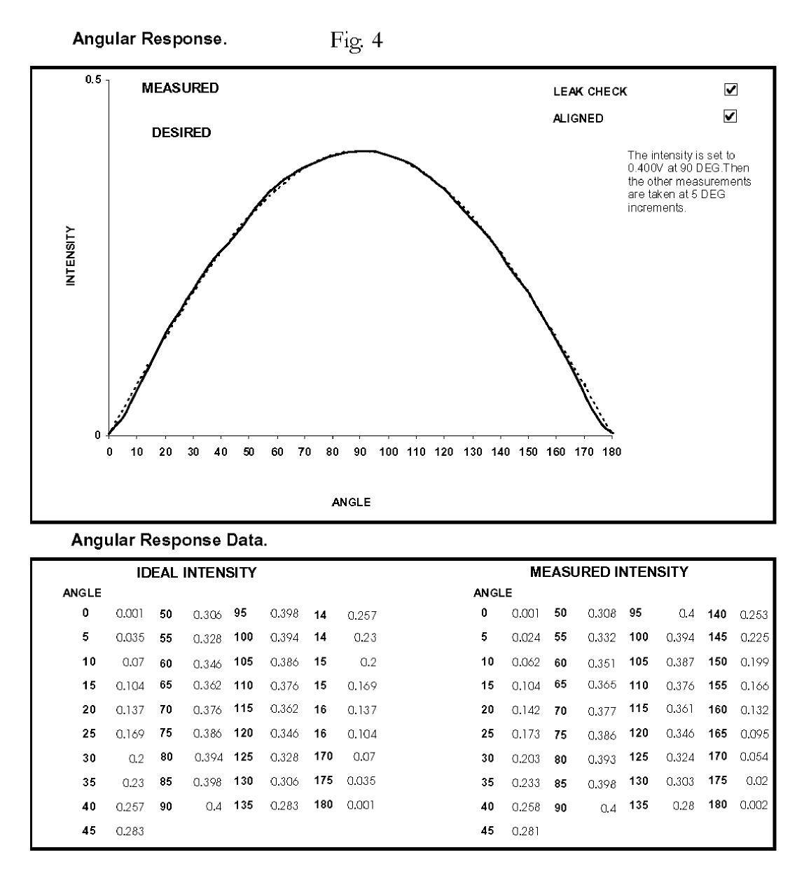

FIG. 4 is graph indicating how the invention during testing closely approximates an ideal lambertian light source by providing a cosine distribution output as a function of angle.

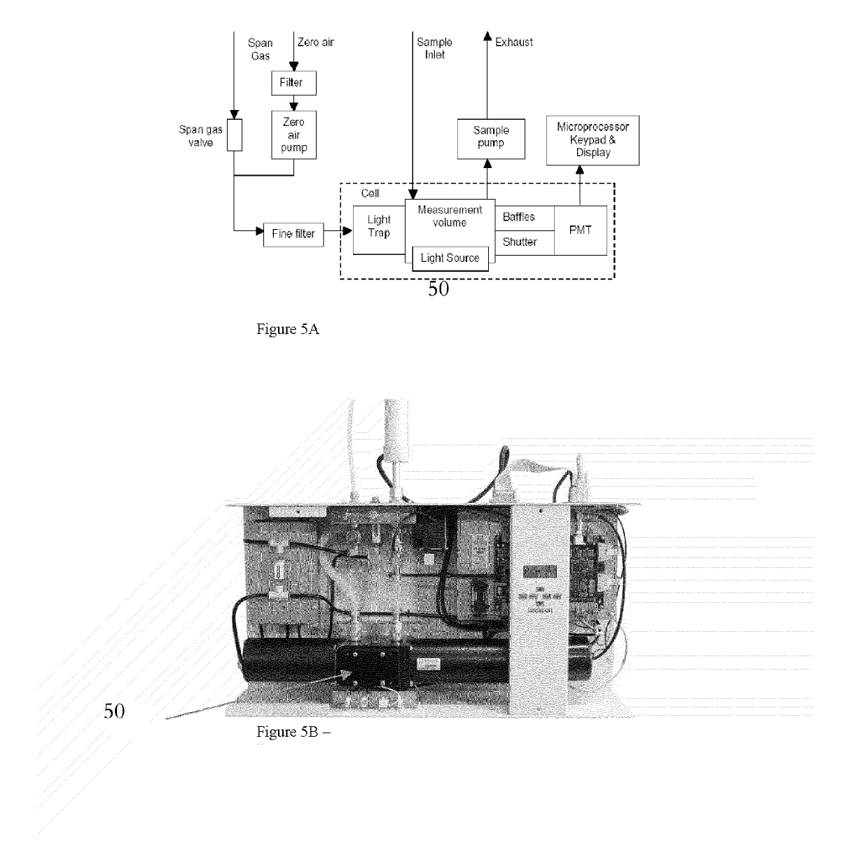

FIG. 5 is a view of a newly available commercial nephelometer incorporating our LED array light source invention.

Operation

In operation we have begun to utilize the LED array in combination with a specially manufactured integrating nephelometer. The LED array module is self contained and can be easily connected into the internal body of a nephelometer via a 4 screw insertion. LED array modules can be connected and disconnected, as different wavelength frequencies are required. The means of achieving a lambertian distribution light source via a light emitting diode array is as follows:

The ideal lambertian light source would consist of a point source providing a cosine distribution as a function of angle. It would also produce no radiated heat as well as requiring minimal power consumption. The wavelength of the light source should be of a very narrow band width. The light output intensity of the light source should be very stable and does not vary with temperature changes.

Our Lambertian Light source consists of the following three main components:

LED Array Printed Circuit Assembly:

Our Light Source consists of seven Light Emitting Diodes (LED) of a very high output intensity (often called super bright LEDs). These LEDs are chosen for not only their very bright output, but also their wavelength (or colour). The wavelength output (typically 525 nm) is very stable and should not vary by more than 30 nm. Other wavelengths can be achieved by using different wavelength LEDs (630 nm for Red, or 470 nm for Blue). The light intensity of each LED is very stable with temperature. The light output intensity of each LED is directly proportional to the amount of current flowing through the LED. So this current also has to be stable. The LEDs also have a narrow beam width angle of 15 degrees, so that most of the light energy can be focused in one spot.

If the light output intensity of each LED was the same, then the combined output distribution of the light source would not be lambertian. That is why we have employed a circuit assembly which individually controls the current through each LED. Each LED is given a discrete driving current (depending on the angular location of the LED) so that the combined effect of all the LEDs is a lambertian distribution. The overall Intensity of the Light Source assembly can be varied by increasing the drive voltage to Light Source. Hence the subsequent current through each LED also will vary accordingly, however the variation in each LED current will be proportional so as to maintain a lambertian light distribution. The other unique feature of the light source circuitry is that it also employs a temperature compensation circuit so that the output intensity of the light source does not vary with changes in ambient temperature. Because LEDs are very efficient, there is minimal heating of the light source from the LEDs. This means that no additional cooling or heat dissipation is required.

Diffuser:

The LEDs are arrayed in a semi-circular arrangement and adjusted so that each LED is focused on the same spot. Hence this produces a very high concentration of light in the one position. At the point where these LEDs are focused, there is a glass diffuser window. The diffuser performs two functions:
It evenly distributes the incident light 170 degrees from the diffuser
Pneumatically seals the electronic components from the ambient air.
   Light Source Housing:
   The Light source housing provides the means by which the LED Array Printed Circuit Assembly and the Diffuser can be mounted and sealed. The housing contains mounting brackets inside to keep the circuit board stable and minimize any heating effects on the ambient air. The housing is made of aluminum and is black anodized as well as having a coating of matt black paint in certain locations to reduce light reflections.
   The overall effect is a very stable Light Source which produces a fixed wavelength of light with a distribution that is Lambertian.

There are many alternative ways that that the invention may be implemented:

The LED array may be an integral component/s of an integrating nephelometer or other instrument that may require a precise and interchangeable light source with specific precise wavelength frequency output of a Lambertian distribution.

The LED array, and by inference the resulting LED light source, may be differently shaped, may contain different quantities of LED's, may contain variations on the nature of the circuitry controlling each LED, and may have different types of housing and diffusors.

The LED array may be connected to various types of instruments, or may be used concurrently and in combination with two or more other LED arrays of differing light output wavelength frequencies.

The LED array may be comprised of one or more sections.

The LED array may be encapsulated in a container other than the container shown here.

1. An LED array that is capable of providing a very stable Light Source which produces a fixed wavelength of light with a distribution that is lambertian, comprising:
(a) a semi circular, or any other shaped, array of high intensity LEDs,
(b) an external casing
(c) a means for controlling, via microprocessor, the individual currents to each LED in the LED array, whereby light from each individual LED is focused to a point, which then results in a total light emission that is of a specific wavelength frequency, so that said Light Source can be used for precision measurement of light scattering or other applications which require a reliable precise and fixed wavelength.

2. The system of claim 1 wherein said LED array is easily removable and replaceable.

3. The system of claim 1 wherein there is a means to automatically compensate for any potential alteration in light intensity in the event of failure of one or more individual LEDs in the LED array, via circuitry to moderate the current provided to each remaining individual LED in the array, ensuring that the total light intensity continues to remain constant.
